(19) United States
(12) Patent Application Publication
(10) Pub. No.: US 2024/0212062 A1
(43) Pub. Date: Jun. 27, 2024

(54) SYSTEMS AND METHODS TO ASSOCIATE ONLINE CUSTOMERS OF A BRAND IN AN ONLINE STORE WITH A SOCIAL MEDIA PLATFORM

(71) Applicant: The Bounty App, Inc. (dba Bounty), Miami, FL (US)

(72) Inventors: Aaron Robert Decker, Milford, OH (US); Marcus Shane Wood, Meadows of Dan, VA (US); Justin Lambert, Shaker Heights, OH (US); Abraham Wolke, Miami, FL (US)

(21) Appl. No.: 18/069,647

(22) Filed: Dec. 21, 2022

(51) Int. Cl. G06Q 50/00

(52) U.S. Cl. CPC G06Q 50/01

(57) ABSTRACT

Systems and methods configured to associate online customers of a brand in an online store with a social media platform profile are disclosed. Exemplary implementations may: receive contact information of users via a webpage presented to users using client computing platforms, the webpage may be on a website facilitating exchanges between users and the brand; create social profiles associated with the users, responsive to receipt of contact information; transmit tokens to the client computing platforms; receive exchange information characterizing exchanges facilitated between the users and the brand; attribute exchanges to the users; store associations between the social profiles and exchanges; contact the users via the contact information; receive requests to connect the social profiles to social media platform profiles; store associations between the social profiles and the social media platform profiles; receive social media activity information; and determine whether posts associated with the social media platform profiles serve as promotions.

### FIELD OF THE DISCLOSURE

The present disclosure relates to systems and methods configured to associate online customers of a brand in an online store with a social media platform profile.

### BACKGROUND

Websites that function as online stores for brands are known. Usage of social media platforms (e.g., Instagram, TikTok, etc.) for advertising is known. Payment to content creators for creating advertisements for display on social media platforms is known.

### SUMMARY

One aspect of the present disclosure relates to a system configured to associate online customers of a brand in an online store with a social media platform profile. The system may include one or more hardware processors configured by machine-readable instructions. The processor(s) may be configured to receive contact information of users from client computing platforms. The individual client computing platforms may include one or more user-definable fields on a webpage. The users may be interested in a first product. The webpage may provide information regarding the first product. The webpage may be one of one or more webpages comprising a website. The webpages may be configured to present products and facilitate exchanges between users and a host hosting the website. The exchanges may include the users exchanging consideration for the products. The processor(s) may be configured to create, responsive to receiving contact information of users, individual social profiles associated with individual users. By way of non-limiting example, responsive to receiving contact information of a first user, a first social profile associated with the first user may be created.

The processor(s) may be configured to transmit, to the individual client computing platforms from which the contact information is received, tokens to be stored on the individual client computing platforms. By way of non-limiting example, responsive to receipt of contact information of the first user received from a first client computing platform, a first token may be transmitted to the first client computing platform for storage on the first client computing platform. The processor(s) may be configured to receive, responsive to execution of an exchange, exchange information characterizing the exchange. By way of non-limiting example, responsive to a first exchange with the first user, first exchange information characterizing the first exchange may be received. The first exchange information may include the first token. The processor(s) may be configured to attribute the exchanges to the individual users based on the presence of the tokens in the exchange information. By way of non-limiting example, the first exchange may be attributed to the first user based on the presence of the first token in the first exchange information.

The processor(s) may be configured to store, responsive to attributing the exchanges to the individual users, associations between the individual social profiles and the exchanges. By way of non-limiting example, an association between the first social profile and the first exchange may be stored. The processor(s) may be configured to contact the users to which the exchanges are attributed via the contact information previously received from the users. By way of non-limiting example, responsive to the first exchange the first user may be contacted via the contact information of the first user.

In some implementations of the system, the website may be an online store for a brand. In some implementations of the system, the exchange information may include a name of a product involved in the exchange and delivery information of the product. In some implementations of the system, the delivery information may include a delivery status, an expected delivery date and/or an actual delivery date of the product. In some implementations of the system, storing associations between the individual social profiles and the exchanges may include storing an association between the individual social profiles and individual brands fulfilling the exchanges.

In some implementations of the system, the processor(s) may be configured to receive a request, from a client computing platform, to connect an individual social profile to an individual social media platform profile. In some implementations of the system, the processor(s) may be configured to store, responsive to the request to connect the individual social profile to the individual social media platform profile, an association between the individual social profile and the individual social media platform profile. In some implementations of the system, the processor(s) may be configured to receive social media activity information associated with the social media platform profile that is associated with the individual social profile. In some implementations of the system, the social media activity information may include post information, a comment made using the social media platform profile, a reaction made using the social media platform profile, and/or other information. Post information for an individual post published using the social media platform profile may include one or more of a status of the post, a number and/or types of reactions on the post, comments on the post, a caption on the post, and/or media content of the post.

Another aspect of the present disclosure relates to a method configured to associate online customers of a brand in an online store with a social media platform profile. The method may include receiving, from client computing platforms, contact information of users. The individual client computing platforms may include one or more user-definable fields on a webpage. The users may be interested in a first product. The webpage may provide information regarding the first product. The webpage may be one of one or more webpages comprising a website. The webpages may be configured to present products and facilitate exchanges between users and a host hosting the website. The exchanges may include the users exchanging consideration for the products. The method may include creating, responsive to receiving contact information of users, individual social profiles associated with the individual users. By way of non-limiting example, responsive to receiving contact information of a first user, a first social profile associated with the first user may be created. The method may include transmitting, to the individual client computing platforms from which the contact information is received, tokens to be stored on the individual client computing platforms. By way of non-limiting example, responsive to receipt of contact information of the first user received from a first client computing platform, a first token may be transmitted to the first client computing platform for storage on the first client computing platform. The method may include receiving, responsive to execution of an exchange, exchange information characterizing the exchange. By way of non-limiting example, responsive to a first exchange with the first user, first exchange information characterizing the first exchange may be received. The first exchange information may include the first token. The method may include attributing the exchanges to the individual users based on the presence of the tokens in the exchange information. By way of non-limiting example, the first exchange may be attributed to the first user based on the presence of the first token in the first exchange information. The method may include storing, responsive to attributing the exchanges to the individual users, associations between the individual social profiles and the exchanges. By way of non-limiting example, an association between the first social profile and the first exchange may be stored. The method may include contacting the users to which the exchanges are attributed via the contact information previously received from the users. By way of non-limiting example, responsive to the first exchange the first user may be contacted via the contact information of the first user.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to associate online customers of a brand in an online store with a social media platform profile, in accordance with one or more implementations.

FIGS. 2A and 2B illustrate a method configured to associate online customers of a brand in an online store with a social media platform profile, in accordance with one or more implementations.

FIG. 3 illustrates a post published on a social media platform, in accordance with one or more implementations.

### DETAILED DESCRIPTION

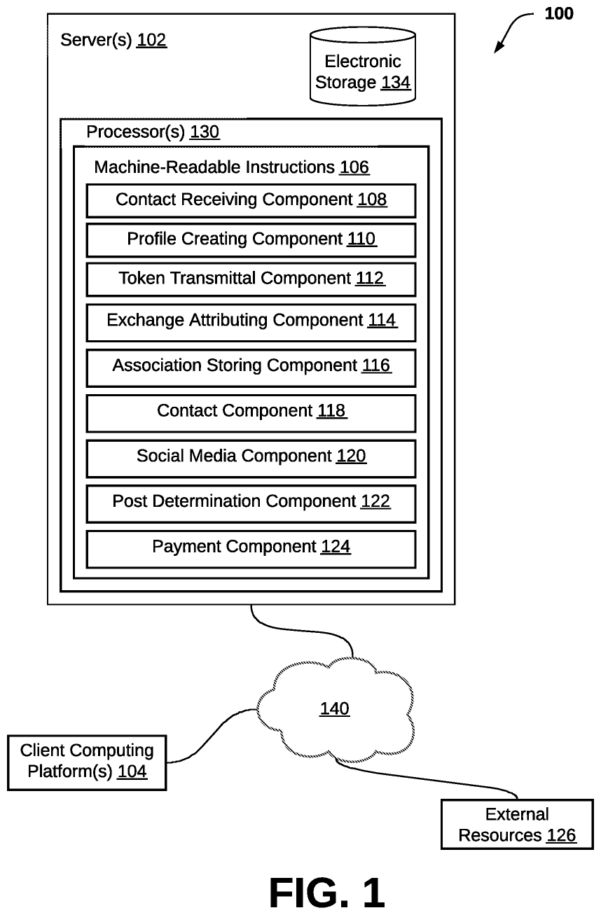

FIG. 1 illustrates a system 100 configured to associate online customers of a brand in an online store with a social media platform profile, in accordance with one or more implementations. In some implementations, system 100 may include one or more servers 102. Server(s) 102 may be configured to communicate with one or more remote platforms 104 according to a client/server architecture, a peer-to-peer architecture, and/or other architectures. Remote platform(s) 104 may be configured to communicate with other remote platforms via server(s) 102 and/or according to a client/server architecture, a peer-to-peer architecture, and/or other architectures. Users may access system 100 via remote platform(s) 104.

Server(s) 102 may be configured by machine-readable instructions 106. Machine-readable instructions 106 may include one or more instruction components. The instruction components may include computer program components. The instruction components may include one or more of contact receiving component 108, profile creating component 110, token transmittal component 112, exchange attributing component 114, association storing component 116, contact component 118, social media component 120, post determination component 122, effectuation initiation component 124, and/or other instruction components.

Contact receiving component 108 may be configured to receive, from individual client computing platforms, contact information of individual users. The contact information of the individual users may include one or more of a phone number, an email address, and/or other forms of contact information. The individual client computing platforms may include one or more user-definable fields on a webpage. The individual users may be interested in a first product. The webpage may provide information regarding the first product. The webpage may be one of one or more webpages comprising a website. By way of non-limiting example, a first user may select one or more forms of contact information to enter via the user-definable fields on a first webpage. The first webpage may be one of one or more webpages that make up a first website. Contact information of the first user may be received responsive to the first user entering one or more forms of contact information associated with the first user via the user-definable fields on the first webpage.

The website may be an online store for a brand. One or more of the webpages comprising the website may be configured to present products offered by the brand. The products may include goods and/or services provided by the brand. Presentation of the products on the website may enable the users to browse and to select products offered by the brand. The website may be accessed by users via a web browser on client computing platforms. One or more of the webpages comprising the website may be configured to facilitate execution of exchanges between users and a host hosting the website. The exchanges may be between users and the brand providing the goods and/or services. The exchanges may include the users exchanging consideration for the products. Exchanging consideration for the products may include the users effectuating payment through one or more of the webpages. Upon effectuation of payment, the host of the website may facilitate delivery of the products to the users. By way of non-limiting example, the first website may be an online store for a first brand. The first website may be accessed by the first user on a first web browser.

Any description herein of the website being an online store for the brand may refer to the website being an online store for one or more brands. The website may be an online store presenting products offered by multiple brands. As used herein, any reference to “the brand” may be used to describe one or more brands offering products on the website. As such, an individual user may be a customer of an online store and/or a customer of one or more individual brands offering products on the online store.

Profile creating component 110 may be configured to create individual social profiles associated with individual users. Creation of the individual social profile associated with the individual user may be responsive to receiving contact information of users. The individual social profile may be used to track the individual user's activity associated with exchanges between the individual user and one or more brands. By way of non-limiting example, responsive to receiving contact information of the first user, a first social profile associated with the first user is created. The first social profile may be used to track the first user's activity associated with exchanges between the first user and one or more brands.

Token transmittal component 112 may be configured to transmit individual tokens to be stored on the individual client computing platforms from which the contact information was received. The individual tokens may be used to confirm identity of individual users using the website. The individual tokens may be transmitted responsive to receiving contact information of individual users. Transmitting individual tokens may include assigning the individual tokens to individual web browsers and persisting the individual tokens according to user activity on web browsers. User activity may include information characterizing shopping on a website, purchasing products on the website, and/or other actions. By way of non-limiting illustration, a first token may be transmitted to the first client computing platform for storage on the first client computing platform responsive to receiving contact information of the first user. Transmitting the first token for storage on the first client computing platform may include assigning the first token to the first web browser and persisting the first token according to first user activity.

The tokens may include unique token identifiers. By way of non-limiting illustration, the first token may include a first unique token identifier. The unique token identifiers may be alphanumeric. Individual tokens may be associated with individual users using unique token identifiers for the individual tokens. By way of non-limiting example, the first token may be associated with the first user. Assigning and persisting tokens with unique token identifiers may enable the system to confirm identity of the individual user.

Exchange attributing component 114 may be configured to receive, responsive to execution of exchanges, exchange information characterizing individual ones of the exchanges. In some implementations, exchange information characterizing an individual exchange may include a token stored on a client computing platform, a name of a product involved in the exchange, a name of an individual brand providing the product, delivery information of the product, and/or other information. The individual exchange may have been executed between the individual user and the individual brand. The individual user may have used an individual client computing platform to facilitate execution of the individual exchange. In some implementations, exchange information characterizing the individual exchange may not include a token if no tokens were stored on the individual client computing platform during execution of the individual exchange.

By way of non-limiting example, responsive to a first exchange with the first user, first exchange information characterizing the first exchange may be received. The first exchange information may include the first token. Exchange attributing component 114 may determine whether a token is stored on the first client computing platform. By way of non-limiting example, responsive to determining whether a token is stored on the first client computing platform, exchange attributing component 114 may retrieve the first token from the first client computing platform. Delivery information of the individual exchange may include a delivery status, an expected delivery date, and/or an actual delivery date of the product. Delivery status may identify a status of delivery of the product including ordered, shipped/on the way, delayed, out for delivery, delivered, lost, and/or other statuses.

Exchange attributing component 114 may be configured to attribute individual ones of the exchanges to the individual users based on the presence of individual tokens associated with the individual users in the exchange information characterizing individual exchanges. Exchange attributing component 114 may be configured to identify an individual user associated with the individual token based on a unique token identifier for the individual token. Exchange attributing component 114 may attribute the individual exchange to the individual user. By way of non-limiting example, the first exchange may be attributed to the first user based on the presence of the first token in the first exchange information, by virtue of the first token being associated with the first user.

Association storing component 116 may be configured to store associations between the individual social profiles and the individual exchanges responsive to attributing the individual exchanges to the individual users. By virtue of an individual social profile being associated with an individual exchange, the individual social profile may be associated with exchange information characterizing the individual exchange. For example, storing associations between the individual social profiles and individual exchanges may include storing an association between the individual social profiles and individual brands fulfilling the exchanges and/or individual products involved in the individual exchanges. By way of non-limiting example, a first association between the first social profile and the first exchange may be stored.

Contact component 118 may be configured to contact the individual users to which the individual exchanges are attributed via the contact information previously received from the individual users. By way of non-limiting example, responsive to the first exchange the first user may be contacted via the contact information of the first user. By way of non-limiting example, the contact may notify the first user that a social profile associated with the first user has been created and enable the first user to facilitate completion of initiation of the first social profile. Completion of initiation of a social profile may include storing an association between the social profile and a social media platform profile. For example, the contact may notify the first user that an exchange attributed to the first user has been facilitated.

Social media component 120 may be configured to receive a request, from a client computing platform, to connect an individual social profile to an individual social media platform profile associated with an individual user. The individual social media platform profile may be managed by an individual social media platform. The social media platform may be a social media service that enables users to create, publish, and/or share content or to participate in social networking. The individual social media platform may be a social networking service (e.g., Instagram, TikTok, Twitter, etc.). The individual social media platform may include a website and/or application that enables users to create, publish, and/or share content. Sharing content may share one or more of information, an idea, an interest, and/or another form of expression through a virtual community or network. Individual social media platform profiles may be used by individual users to create, publish, and/or share content via individual social media platforms. The request may include authenticating the individual social profile to the individual social media platform profile. In some implementations, authenticating the social profile to the individual social media platform profile may include receiving log-in information (e.g., username, password, email address, and/or other information) input by the individual user via the client computing platform and comparing the received information with authentication information managed by the individual social media platform.

In some implementations, the contact information of users and the request to connect an individual social profile to an individual social media platform profile may be received from different client computing platforms. By way of non-limiting example, a first request to connect the first social profile to a first social media platform profile may be received from a second client computing platform. For example, the first client computing platform may be a laptop computer and the second computing platform may be a Smartphone.

Association storing component 116 may be configured to store, responsive to the request to connect the individual social profile to the individual social media platform profile, an association between the individual social profile and the individual social media platform profile. The association between the individual social profile and the individual social media platform profile may be stored responsive to authenticating the social profile to the individual social media platform profile.

Social media component 120 may be configured to receive social media activity information associated with the individual social media platform profile that is associated with the individual social profile. The social media activity information may be received from the individual social media platform by virtue of the individual social profile being authenticated to the individual social media platform profile. In some implementations, social media activity information may include one or more of post information, a comment made using the social media platform profile, information reflecting a reaction made using the social media platform profile, and/or other information. In some implementations, post information for an individual post published using the social media platform profile may include one or more of a status of the post, a number and/or type of reactions on the post, comments on the post, a caption on the post, media content of the post, and/or other information. In some implementations, the post information may include activity of other users associated with the individual post. For example, activity associated with the individual post may include another user shopping with the individual brand responsive to viewing the individual post. A reaction may demonstrate an individual user liking, loving, laughing at, being sad about, being surprised by, and/or demonstrating other emotions regarding the post. A caption on the post may be a description or a comment created and/or published by the individual user associated with the individual social media platform profile. Media content of the post may include one or more of a photo, a video, an audio recording, and/or other forms of media included in the post. In some implementations, social media activity information may indicate that a post was published using the individual social media platform profile. Social media activity information indicating that a post was published may include media (e.g., photos and/or videos) included in the post. For example, the social media activity information may include a number of views of the post within 48 hours of the post being published. In some implementations, social media component 120 may be configured to receive social media activity information indicating that a post has been published using the individual social media platform profile.

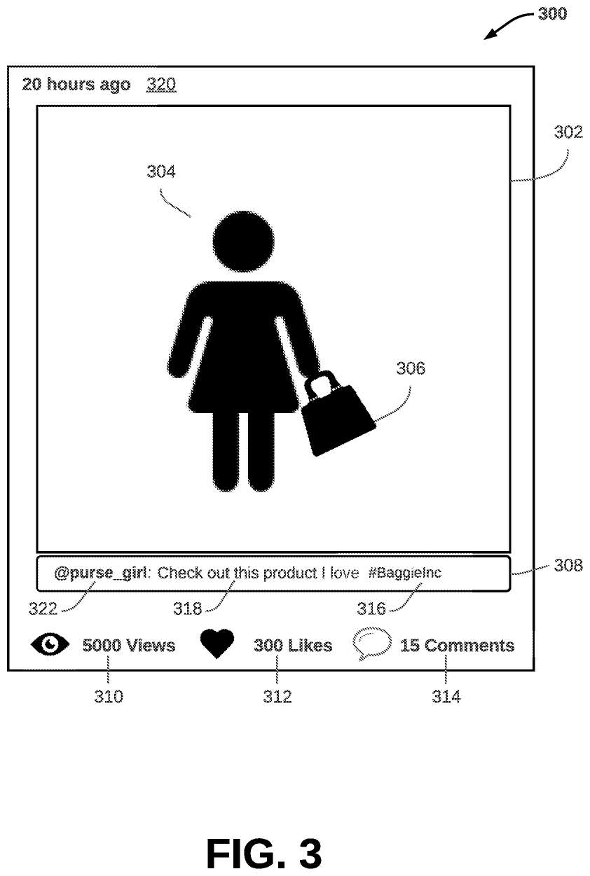

FIG. 3 illustrates a post 300 published on a social media platform. The post 300 may include and/or display a video 302, a caption 308, a number of views 310, a number of likes 312, a number of comments 314, and a duration of time 320. Video 302 may depict a user 304 of the social media platform and a product 306. By way of non-limiting example, video 302 may include audio of user 304 describing product 306. Caption 308 may include a username 322 of the user on the social media platform, a comment 318, and a hashtag 316. Comment 318 may promote product 306 and/or describe video 302. Hashtag 316 may reference a brand providing product 306. Number of views 310 may depict the number of times video 302 has been viewed since post 300 was published. Number of likes 312 may depict the number of users of the social media platform who reacted to post 300 with a like since post 300 was published. Number of comments 314 may depict the number of comments users of the social media platform have published in response to post 300. Duration of time 320 may depict the amount of time (or an approximate amount of time) since post 300 was published.

Returning to FIG. 1, post determination component 122 may be configured to determine whether an individual post on an individual social media platform serves as a promotion for an individual exchange. Posts that serve as promotions for exchanges may publicize one or more products involved in the exchange and/or one or more brands facilitating the exchanges so as to increase sales or public awareness. Post determination component 122 may be configured to access social media activity associated with individual social media platform profiles received by social media component 120. Determining whether an individual post serves as a promotion may include searching post information for the individual post included in social media activity information associated with an individual social media platform profile for necessary information. By way of non-limiting example, the necessary information may include one or more of a particular word in a caption, a particular hashtag in the caption, audio describing products involved in the individual exchange in the media content of the post, and/or a visual representation of the products involved in the individual exchange in the media content of the post. Visual representation of the products involved in the exchange may include an image and/or a video of one or more of the products involved in the exchange. A hashtag may be a word or a used on social media platforms to identify digital content on a specific topic. In some implementations, a hashtag may include a hash sign. For example, the necessary information for a post serving as a promotion may include positively describing one or more of the products within audio included in the post and/or within a caption on the post. For example, the necessary information may include the post including a visual depiction or representation of one or more of the products.

Payment component 128 may be configured to initiate effectuation of payment to the individual user, responsive to determining the individual post is a promotion for the exchange. Initiating effectuation of payment to the individual user may include identifying the individual social profile associated with the social media platform profile through which the individual post was published. Initiating effectuation of payment to the individual user may include identifying the individual user associated with the individual social profile. In some implementations, the payment may be scaled according to post information characterizing the individual post. By way of non-limiting example, an amount of the payment may be scaled according to a number of views of the individual post during the first 48 hours after creation of the post. In some implementations, individual brands may adjust how the payment is scaled.

Contact component 118 may be configured to contact responsive to the exchange information indicating that the product involved in the exchange has been delivered and/or responsive to passage of a specified amount of time. The specified amount of time may be a week, a month, 30 days, or another amount of time. The user to which the exchange may be attributed via the contact information previously received from the user. Contacting the user may prompt the user to confirm engagement regarding the exchange with an individual social profile associated with the user. By way of non-limiting example, responsive to the first exchange information indicating the exchange has been delivered or responsive to passage of a specified amount of time the first user may be contacted via the contact information of the first user.

In some implementations, server(s) 102, remote platform(s) 104, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, remote platform(s) 104, and/or external resources 126 may be operatively linked via some other communication media.

A given remote platform 104 may include one or more processors configured to execute computer program components. The computer program components may be configured to enable an expert or user associated with the given remote platform 104 to interface with system 100 and/or external resources 126, and/or provide other functionality attributed herein to remote platform(s) 104. By way of non-limiting example, a given remote platform 104 and/or a given server 102 may include one or more of a server, a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 134, one or more processors 130, and/or other components. Server(s) 102 may include communication lines, or ports to enable the exchange of information with a network and/or other servers. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 134 may comprise non-transitory storage media that electronically stores information. The electronic storage media of electronic storage 134 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 134 may include one or more virtual storage resources (e.g., cloud storage, a virtual private network, and/or other virtual storage resources). Electronic storage 134 may store software algorithms, information determined by processor(s) 130, information received from server(s) 102, information received from remote platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 118, 120, 122, and/or 124, and/or other components. Processor(s) 130 may be configured to execute components 108, 110, 112, 114, 118, 120, 122, and/or 124, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 118, 120, 122, and/or 124 are illustrated in FIG. 1 as being implemented within a single processing unit, in implementations in which processor(s) 130 includes multiple processing units, one or more of components 108, 110, 112, 114, 118, 120, 122, and/or 124 may be implemented remotely from the other components. The description of the functionality provided by the different components 108, 110, 112, 114, 118, 120, 122, and/or 124 described below is for illustrative purposes, and is not intended to be limiting, as any of components 108, 110, 112, 114, 118, 120, 122, and/or 124 may provide more or less functionality than is described. For example, one or more of components 108, 110, 112, 114, 118, 120, 122, and/or 124 may be eliminated, and some or all of its functionality may be provided by other ones of components 108, 110, 112, 114, 118, 120, 122, and/or 124. As another example, processor(s) 130 may be configured to execute one or more additional components that may perform some or all of the functionality attributed below to one of components 108, 110, 112, 114, 118, 120, 122, and/or 124.

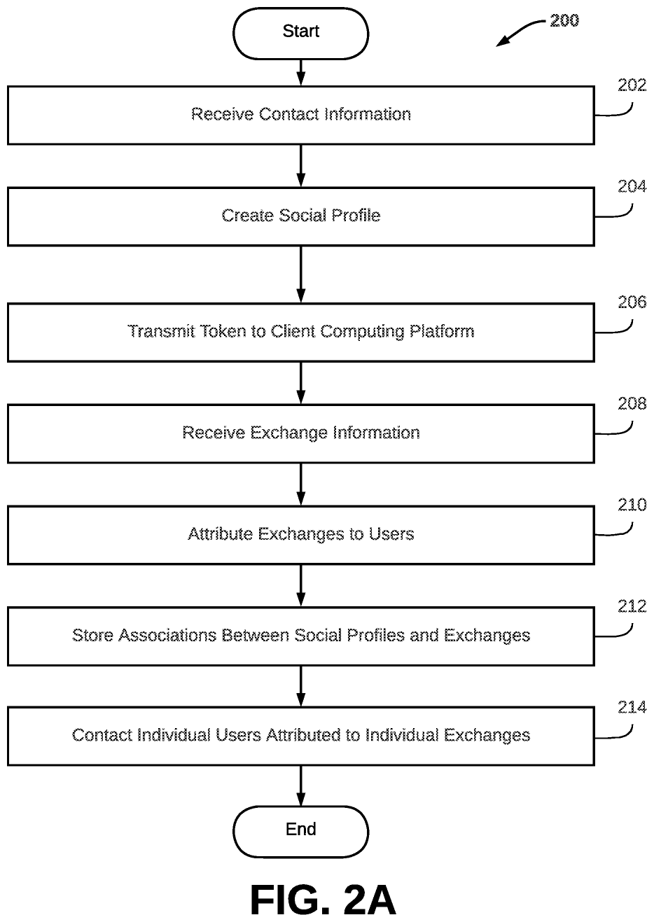

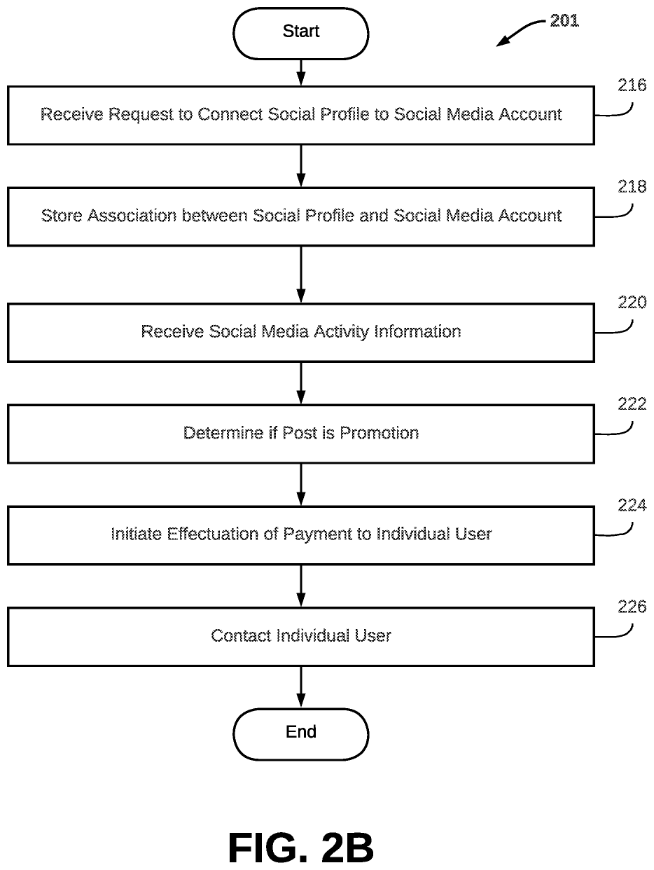

FIGS. 2A and 2B illustrates methods 200 and 201, respectively, configured to associate online customers of a brand in an online store with a social media platform profile, in accordance with one or more implementations. The operations of methods 200 and 201 presented below are intended to be illustrative. In some implementations, methods 200 and 201 may be accomplished with one or more additional operations not described, and/or without one or more of the operations discussed. Additionally, the order in which the operations of methods 200 illustrated in FIG. 2A and the operations of method 201 illustrated in FIG. 2B described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200. FIG. 2A illustrates method 200, in accordance with one or more implementations.

An operation 202 may include receiving, from client computing platforms, contact information of users. The individual client computing platforms may include one or more user-definable fields on a webpage. The users may be interested in a first product. The webpage may provide information regarding the first product. The webpage may be one of one or more webpages including a website. The webpages may be configured to present products and facilitate exchanges between users and a host hosting the website. The exchanges may include the users exchanging consideration for the products. By way of non-limiting example, a first user may select one or more forms of contact information to enter via the user-definable fields on a first webpage. The first webpage may be one of one or more webpages comprising a first website. Contact information of the first user may be received responsive to the first user entering one or more forms of contact information associated with the first user via the user-definable fields on the first webpage. Operation 202 may be performed by one or more hardware processors configured by machine-readable instructions including a component that is the same as or similar to contact receiving component 108, in accordance with one or more implementations.

An operation 204 may include creating, responsive to receiving contact information of users, individual social profiles associated with the individual users. By way of non-limiting example, responsive to receiving contact information of the first user, a first social profile associated with the first user may be created. Operation 204 may be performed by one or more hardware processors configured by machine-readable instructions including a component that is the same as or similar to profile creating component 110, in accordance with one or more implementations.

An operation 206 may include transmitting, to the individual client computing platforms from which the contact information is received, tokens to be stored on the individual client computing platforms. Transmitting individual tokens may include assigning the individual tokens to individual web browsers and persisting the individual tokens according to user activity on web browsers. By way of non-limiting example, responsive to receipt of contact information of the first user received from a first client computing platform, a first token may be transmitted to the first client computing platform for storage on the first client computing platform. Operation 206 may be performed by one or more hardware processors configured by machine-readable instructions including a component that is the same as or similar to token transmittal component 112, in accordance with one or more implementations.

An operation 208 may include receiving, responsive to execution of exchanges, exchange information characterizing the exchanges. In some implementations, exchange information characterizing an individual exchange may include a token stored on a client computing platform, a name of a product involved in the exchange, a name of an individual brand providing the product, and delivery information of the product. The individual exchange may have been executed between the individual user and the individual brand. In some implementations, prior to receiving the exchange information, exchange attributing component 114 may be configured to determine whether a token is stored on a client computing platform. By way of non-limiting example, responsive to a first exchange with the first user, first exchange information characterizing the first exchange may be received. The first exchange information may include the first token. Responsive to determining a token is stored on the client computing platform, exchange attributing component 114 may be configured to receive the exchange information. Operation 208 may be performed by one or more hardware processors configured by machine-readable instructions including a component that is the same as or similar to exchange attributing component 114, in accordance with one or more implementations.

An operation 210 may include attributing individual ones of the exchanges to the individual users based on the presence of the tokens in the exchange information. By way of non-limiting example, the first exchange may be attributed to the first user based on the presence of the first token in the first exchange information. Operation 210 may be performed by one or more hardware processors configured by machine-readable instructions including a component that is the same as or similar to exchange attributing component 114, in accordance with one or more implementations.

An operation 212 may include storing, responsive to attributing the exchanges to the individual users, associations between the individual social profiles and the exchanges. By virtue of an individual social profile being associated with an individual exchange, the individual social profile may be associated with exchange information characterizing the individual exchange. For example, storing associations between the individual social profiles and individual exchanges may include storing an association between the individual social profiles and individual brands fulfilling the exchanges and/or individual products involved in the individual exchanges. By way of non-limiting example, a first association between the first social profile and the first exchange may be stored. Operation 212 may be performed by one or more hardware processors configured by machine-readable instructions including a component that is the same as or similar to association storing component 116, in accordance with one or more implementations.

An operation 214 may include contacting the users to which the exchanges are attributed via the contact information previously received from the users. By way of non-limiting example, responsive to the first exchange the first user may be contacted via the contact information of the first user. By way of non-limiting example, the contact may notify the first user that a social profile associated with the first user has been created and enable the first user to facilitate completion of initiation of the first social profile. For example, the contact may notify the first user that an exchange attributed to the first user has been facilitated. Operation 214 may be performed by one or more hardware processors configured by machine-readable instructions including a component that is the same as or similar to contact component 118, in accordance with one or more implementations.

In some implementations, method 201 (shown in FIG. 2B) may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 201 in response to instructions stored electronically on an electronic storage medium. The one or more processing devices may include one or more devices configured through hardware, firmware, and/or software to be specifically designed for execution of one or more of the operations of method 201. FIG. 2B illustrates method 201, in accordance with one or more implementations. In some implementations, the operations of method 201 may be performed after or responsive to the operations of method 200 (shown in FIG. 2A).

An operation 216 may include receiving a request, from a client computing platform, to connect an individual social profile to an individual social media platform profile. The request may include authenticating the individual social profile to the individual social media platform profile. In some implementations, authenticating the social profile to the individual social media platform profile may include receiving log-in information (e.g., username, password, email address, and/or other information) input by the individual user via the client computing platform and comparing the received information with authentication information managed by the individual social media platform. Operation 216 may be performed by one or more hardware processors configured by machine-readable instructions including a component that is the same as or similar to social media component 120, in accordance with one or more implementations.

An operation 218 may include storing, responsive to the request to connect the individual social profile to the individual social media platform profile, an association between the individual social profile and the individual social media platform profile. The association between the individual social profile and the individual social media platform profile may be stored responsive to authenticating the social profile to the individual social media platform profile. Operation 218 may be performed by one or more hardware processors configured by machine-readable instructions including a component that is the same as or similar to association storing component 116, in accordance with one or more implementations.

An operation 220 may include receiving social media activity information associated with the social media platform profile that is associated with the individual social profile. The social media activity information may be received from the individual social media platform by virtue of the individual social profile being authenticated to the individual social media platform profile. The social media activity information may include post information, a comment on a post or profile, information reflecting a reaction to a post or profile, and/or other information. In some implementations, post information for an individual post published using the social media platform profile includes one or more of a status of the post, a number and/or type of reactions on the post, comments on the post, a caption on the post, media content of the post, and/or other information. In some implementations, the post information may include activity of other users associated with the individual post. In some implementations, operation 220 may include receiving social media activity information indicating that a post has been published using the individual social media platform profile. Operation 220 may be performed by one or more hardware processors configured by machine-readable instructions including a component that is the same as or similar to social media component 120, in accordance with one or more implementations.

An operation 222 may include determining whether the post is a promotion for the exchange. Determining whether the post may be a promotion includes searching the social media activity information for necessary information. The necessary information may include one or more of a particular word in the caption, a particular hashtag in the caption, audio may describe the products involved in the exchange in the media content of the post, and/or a visual representation of the products involved in the exchange in the media content of the post. Operation 224 may be performed by one or more hardware processors configured by machine-readable instructions including a component that is the same as or similar to social media component 120, in accordance with one or more implementations.

An operation 224 may include initiating effectuation of payment to the individual user, responsive to determining the post is a promotion for the exchange. Operation 224 may be performed by one or more hardware processors configured by machine-readable instructions including a component that is the same as or similar to payment component 124, in accordance with one or more implementations.

An operation 226 may include contacting, responsive to exchange information for the individual exchange indicating that the product involved in the exchange has been delivered or responsive to passage of a specified amount of time, the individual user to which the individual exchange was attributed. The individual user may be contacted via the contact information previously received from the individual user. Contacting the individual user may prompt the user to confirm engagement regarding the exchange with an individual social profile associated with the user. By way of non-limiting example, responsive to the first exchange information indicating the exchange has been delivered or responsive to passage of a specified amount of time the first user is contacted via the contact information of the first user. Operation 226 may be performed by one or more hardware processors configured by machine-readable instructions including a component that is the same as or similar to contact component 124, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to associate online customers of a brand in an online store with a social media platform profile, the system comprising:
one or more hardware processors configured by machine-readable instructions to:
receive, from individual client computing platforms, contact information of individual users, the individual client computing platforms including one or more user-definable fields on a webpage, the individual users being interested in a first product, the webpage providing information regarding the first product, the webpage being one of one or more webpages comprising a website, the webpages being configured to present products and facilitate exchanges between individual users and a host hosting the website, the exchanges including the individual users exchanging consideration for the products;
create, responsive to receiving contact information of the individual users, individual social profiles associated with individual users, such that responsive to receiving contact information of a first user, a first social profile associated with the first user is created;
transmit, to the individual client computing platforms from which the contact information is received, individual tokens to be stored on the individual client computing platforms, such that a first token is transmitted to the first client computing platform for storage on the first client computing platform;
receive, responsive to execution of one or more exchanges, exchange information for individual ones of the one or more exchanges, the exchange information characterizing the individual ones of the exchanges, such that responsive to a first exchange with the first user, first exchange information characterizing the first exchange is received, the first exchange information including the first token;
attribute the individual ones of the exchanges to the individual users based on the presence of individual tokens in the exchange information, such that the first exchange is attributed to the first user based on the presence of the first token in the first exchange information;
store, responsive to attributing the individual ones of the exchanges to the individual users, associations between the individual social profiles and the individual ones of the exchanges, such that an association between the first social profile and the first exchange is stored; and
contact the individual users to which individual ones of the exchanges are attributed via the contact information previously received from the individual users, such that responsive to the first exchange the first user is contacted via the first contact information of the first user.

2. The system of claim 1, wherein the website is an online store for a brand.

3. The system of claim 1, wherein storing associations between the individual social profiles and individual ones of the exchanges includes storing associations between the individual social profiles and individual brands fulfilling the exchanges.

4. The system of claim 1, wherein the individual tokens include unique token identifiers such that the first token includes a first unique token identifier.

5. The system of claim 1, wherein the exchange information characterizing an individual exchange includes a name of a product involved in the exchange and delivery information of the product, wherein the delivery information includes a delivery status, an expected delivery date and/or an actual delivery date of the product.

6. The system of claim 1, wherein the one or more hardware processors are configured to:
receive a request, from an individual client computing platform, to connect an individual social profile to an individual social media platform profile;
store, responsive to the request to connect the individual social profile to the individual social media platform profile, an association between the individual social profile and the individual social media platform profile; and
receive social media activity information associated with the individual social media platform profile that is associated with the individual social profile, the social media activity information including post information, a comment on a post or profile, and/or information reflecting a reaction to a post or profile, wherein social media activity information includes one or more of post information, a comment made using the individual social media platform profile, and/or information reflecting a reaction made using the individual social media platform profile, wherein post information for an individual post published using the individual social media platform profile includes one or more of a status of the post, a number and/or type of reactions on the post, comments on the post, a caption on the post, and/or media content of the post.

7. The system of claim 6, wherein the contact information of users and the request to connect an individual social profile to an individual social media platform profile are received from different client computing platforms.

8. The system of claim 6, wherein the social media activity information indicates that a post has been published using the individual social media platform profile, and wherein the one or more hardware processors are configured to:
determine whether the post serves as a promotion for the exchange, wherein determining whether the post serves as a promotion includes searching the social media activity information for necessary information, the necessary information may include one or more of a particular word in the caption, a particular hashtag in the caption, audio describing the products involved in the exchange in the media content of the post, and/or a visual representation of the products involved in the exchange in the media content of the post; and
initiate effectuation of payment to the individual user associated with the individual social profile, responsive to determining the post serves as a promotion for the exchange.

9. The system of claim 1, wherein the one or more hardware processors are configured to:
contact, responsive to exchange information for an individual exchange indicating that the product involved in the exchange has been delivered or responsive to passage of a specified amount of time, an individual user to which the individual exchange is attributed via the contact information previously received from the user, wherein contacting the individual user prompts the user to confirm engagement regarding the exchange with an individual social profile associated with the user, such that responsive to the first exchange information indicating the exchange has been delivered or responsive to passage of a specified amount of time the first user is contacted via the contact information of the first user.

10. A method configured to associate online customers of a brand in an online store with a social media platform profile, the method comprising:
receiving, from individual client computing platforms, contact information of individual users, the individual client computing platforms including one or more user-definable fields on a webpage, the individual users being interested in a first product, the webpage providing information regarding the first product, the webpage being one of one or more webpages comprising a website, the webpages being configured to present products and facilitate exchanges between individual users and a host hosting the website, the exchanges including the individual users exchanging consideration for the products;
creating, responsive to receiving contact information of the individual users, individual social profiles associated with individual users, such that responsive to receiving contact information of a first user, a first social profile associated with the first user is created;
transmitting, to the individual client computing platforms from which the contact information is received, individual tokens to be stored on the individual client computing platforms, such that a first token is transmitted to the first client computing platform for storage on the first client computing platform;
receiving, responsive to execution of one or more exchanges, exchange information for individual ones of the one or more exchanges, the exchange information characterizing the individual ones of the exchanges, such that responsive to a first exchange with the first user, first exchange information characterizing the first exchange is received, the first exchange information including the first token;
attributing the individual ones of the exchanges to the individual users based on the presence of individual tokens in the exchange information, such that the first exchange is attributed to the first user based on the presence of the first token in the first exchange information;
storing, responsive to attributing the individual ones of the exchanges to the individual users, associations between the individual social profiles and the individual ones of the exchanges, such that an association between the first social profile and the first exchange is stored; and
contacting the individual users to which individual ones of the exchanges are attributed via the contact information previously received from the individual users, such that responsive to the first exchange the first user is contacted via the first contact information of the first user.

11. The method of claim 10, wherein the website is an online store for a brand.

12. The method of claim 10, wherein storing associations between the individual social profiles and individual ones of the exchanges includes storing associations between the individual social profiles and individual brands fulfilling the exchanges.

13. The method of claim 10, wherein the individual tokens include unique token identifiers such that the first token includes a first unique token identifier.

14. The method of claim 10, wherein the exchange information characterizing an individual exchange includes a name of a product involved in the exchange and delivery information of the product, wherein the delivery information includes a delivery status, an expected delivery date and/or an actual delivery date of the product.

15. The method of claim 10, wherein the method comprises:
receiving a request, from an individual client computing platform, to connect an individual social profile to an individual social media platform profile;
storing, responsive to the request to connect the individual social profile to the individual social media platform profile, an association between the individual social profile and the individual social media platform profile; and
receiving social media activity information associated with the individual social media platform profile that is associated with the individual social profile, the social media activity information including post information, a comment on a post or profile, and/or information reflecting a reaction to a post or profile, wherein social media activity information includes one or more of post information, a comment made using the individual social media platform profile, and/or information reflecting a reaction made using the individual social media platform profile, wherein post information for an individual post published using the individual social media platform profile includes one or more of a status of the post, a number and/or type of reactions on the post, comments on the post, a caption on the post, and/or media content of the post.

16. The method of claim 15, wherein the contact information of users and the request to connect an individual social profile to an individual social media platform profile are received from different client computing platforms.

17. The method of claim 15, wherein the social media activity information indicates that a post has been published using the individual social media platform profile, and wherein the method comprises:
determining whether the post serves as a promotion for the exchange, wherein determining whether the post serves as a promotion includes searching the social media activity information for necessary information, the necessary information may include one or more of a particular word in the caption, a particular hashtag in the caption, audio describing the products involved in the exchange in the media content of the post, and/or a visual representation of the products involved in the exchange in the media content of the post; and
initiating effectuation of payment to the individual user associated with the individual social profile, responsive to determining the post serves as a promotion for the exchange.

18. The method of claim 10, wherein the method comprises:
contacting, responsive to exchange information for an individual exchange indicating that the product involved in the exchange has been delivered or responsive to passage of a specified amount of time, an individual user to which the individual exchange is attributed via the contact information previously received from the user, wherein contacting the individual user prompts the user to confirm engagement regarding the exchange with an individual social profile associated with the user, such that responsive to the first exchange information indicating the exchange has been delivered or responsive to passage of a specified amount of time the first user is contacted via the contact information of the first user.
